(19) United States
(12) Patent Application Publication
(10) Pub. No.: US 2010/0153995 A1
(43) Pub. Date: Jun. 17, 2010

(54) RESUMING A SELECTED VIEWING CHANNEL

(75) Inventors: Steven M. Belz, Cedar Park, TX (US); James Pratt, Round Rock, TX (US); Marc Sullivan, Austin, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/334,075

(22) Filed: Dec. 12, 2008

(51) Int. Cl. H04N 5/445

(52) U.S. Cl. 725/39

(57) ABSTRACT

A method and system for resuming a desired program on a selected viewing channel is provided using a multimedia content distribution network (MCDN). A user of the MCDN may select a primary channel for viewing the desired program transmitted by the MCDN. The MCDN may also transmit channel metadata for detecting interruptions to programs. During an interruption to the desired program, the user may become distracted, for example, by selecting a second viewing channel. A resume alert may be provided to indicate that the interruption has ended and that the desired program has resumed.

### BACKGROUND

1. Field of the Disclosure

The present disclosure relates to viewing multimedia content and, more particularly, to resuming a selected viewing channel.

2. Description of the Related Art

A viewer of multimedia content, such as a television program, on a viewing channel may elect not to view the channel during an interruption in the multimedia content, such as a commercial. During such interruption, the viewer may elect to watch another viewing channel.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia distribution network;

FIG. 3 is a block diagram of selected elements of an embodiment of a multimedia handling device;

FIG. 4 illustrates an embodiment of a method for resuming a selected viewing channel; and

FIG. 5 illustrates an embodiment of a method for resuming a selected viewing channel.

### DESCRIPTION OF EXEMPLARY EMBODIMENTS

In one aspect, a disclosed method for accessing multimedia content over a multimedia content distribution network (MCDN) includes receiving multimedia content from the MCDN, including receiving metadata coordinated in time with the multimedia content. Responsive to user input, the method may further include selecting a primary viewing channel from a plurality of viewing channels available with the multimedia content, such that said selecting indicates a desired program transmitted on the primary viewing channel. When an interruption of the desired program has ceased, the method may include outputting an alert indicating that the desired program has resumed transmission, whereby the metadata are used to identify the interruption. The plurality of viewing channels may represent television channels. The television channels may be provided by the MCDN as Internet-protocol television (IPTV).

In some embodiments, the commercial interruption may include at least one advertising program. The alert may be an audio alert. In some cases, the alert may be a haptic alert on a remote control device configured to control channel selection. A secondary viewing channel may be selected after the interruption of the desired program begins, while the alert may be a visual alert with a control option to return to the primary viewing channel.

In a further aspect, a disclosed system for accessing multimedia content over an MCDN includes a processor and memory media accessible to the processor, including processor executable instructions. The instructions may be executable to decode multimedia content received from the MCDN, including receiving channel metadata coordinated in time for a plurality of viewing channels of the multimedia content, and respond to a user selection of a viewing channel from the plurality of viewing channels by outputting a desired program transmitted on the viewing channel. After an interruption of the desired program has ended, the instructions may further be executable to output an alert indicating that the desired program has resumed transmission, such that the channel metadata are used to identify a beginning and an end of the interruption.

In yet another aspect, a disclosed computer-readable memory media includes executable instructions for processing multimedia content delivered over an MCDN. The instructions may be executable to make a plurality of viewing channels available to a client of the MCDN, respond to a user selection of a viewing channel from the plurality of viewing channels by outputting a desired program transmitted on the viewing channel, and detect, from metadata included with the viewing channel, a beginning and an end of an interruption of the desired program. After detecting the end of the interruption of the desired program, the instructions may be executable to output a resume alert to the client indicating that the desired program has resumed.

In some instances, after the interruption has begun, the instructions may further be executable to output an interrupt alert to the client indicating that the desired program has been interrupted. The interruption may be an advertisement. The interruption may be unscheduled programming. During the interruption, the instructions may be executable to respond to a user selection of a second channel by outputting a second program transmitted on the second channel, wherein the resume alert is a visual alert.

In certain embodiments, the visual alert may be a menu prompt including an option to cancel the resume alert and continue viewing the second channel. The visual alert may be a display element on a wireless remote control device for selecting viewing channels. The resume alert may include a response option to return to the viewing channel. The resume alert may be an audible alert. The audible alert may be a voice alert. The resume alert may be a haptic alert. The haptic alert may be implemented on a wireless telephony device.

The channel metadata may include at least one counter value for tracking the duration that the desired program is transmitted. The counter value may count individual frames of the desired program. The channel metadata may include at least one frame identifier used for identifying the desired program. The interruption may be a commercial program. The alert may be an audible alert. The alert may be a haptic alert on a remote control device configured to control channel selection.

In some embodiments, after the interruption of the desired program begins, the instructions may be executable to output a message indicating that the interruption has been detected. The instructions may further be executable to respond to a user selection of a second channel from the plurality of viewing channels by outputting a second program transmitted on the second channel. The alert may be a visual alert with a response option to return to the viewing channel.

In the following description, details are set forth by way of example to facilitate discussion of the disclosed subject matter. It should be apparent to a person of ordinary skill in the field, however, that the disclosed embodiments are exemplary and not exhaustive of all possible embodiments.

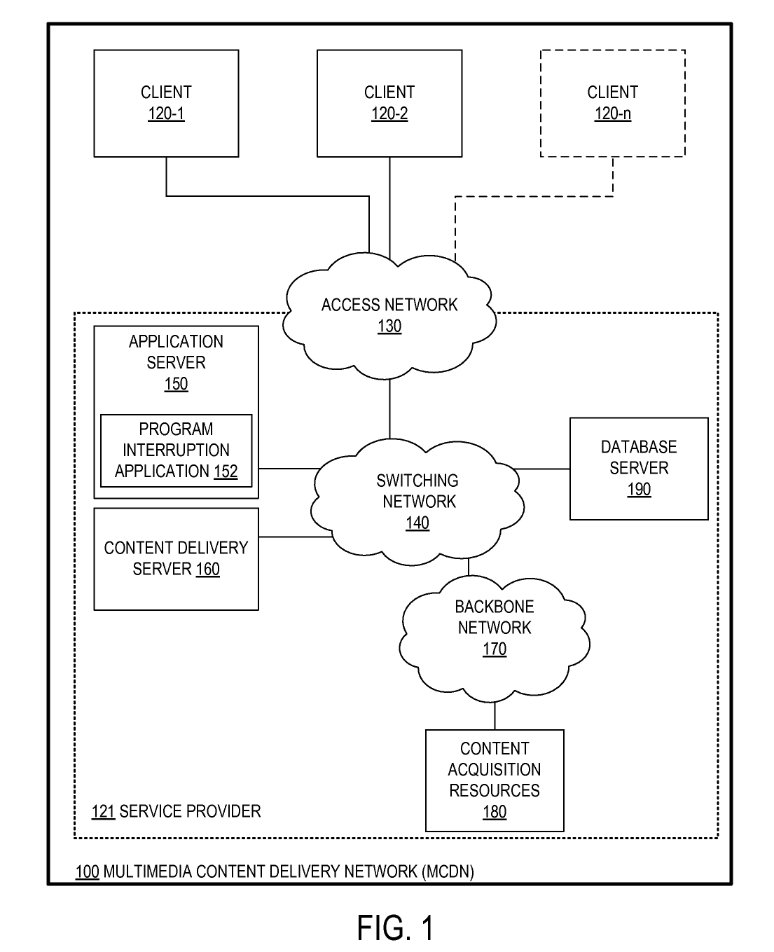

Turning now to the drawings, FIG. 1 is a block diagram illustrating selected elements of an embodiment of an MCDN 100. Although multimedia content is not limited to TV, video on demand (VOD), or pay-per-view (PPV) programs, the depicted embodiments of MCDN 100 and its capabilities are primarily described herein with reference to these types of multimedia content, which are interchangeably referred to herein as multimedia content, multimedia content program(s), multimedia programs or, simply, programs.

The elements of MCDN 100 illustrated in FIG. 1 depict network embodiments with functionality for delivering multimedia content to a set of one or more subscribers. It is noted that different embodiments of MCDN 100 may include additional elements or systems (not shown in FIG. 1 for clarity) as desired for additional functionality, such as data processing systems for billing, content management, customer support, operational support, or other business applications.

As depicted in FIG. 1, MCDN 100 includes one or more clients 120 and a service provider 121. Each client 120 may represent a different subscriber of MCDN 100. In FIG. 1, a plurality of n clients 120 is depicted as client 120-1, client 120-2 to client 120-n, where n may be a large number. Service provider 121 as depicted in FIG. 1 encompasses resources to acquire, process, and deliver programs to clients 120 via access network 130. Such elements in FIG. 1 of service provider 121 include content acquisition resources 180 connected to switching network 140 via backbone network 170, as well as application server 150, database server 190, and content delivery server 160, also shown connected to switching network 140.

Access network 130 demarcates clients 120 and service provider 121, and provides connection path(s) between clients 120 and service provider 121. In some embodiments, access network 130 is an Internet protocol (IP) compliant network. In some embodiments, access network 130 is, at least in part, a coaxial cable network. It is noted that in some embodiments of MCDN 100, access network 130 is owned and/or operated by service provider 121. In other embodiments, a third part may own and/or operate at least a portion of access network 130.

In IP-compliant embodiments of access network 130, access network 130 may include a physical layer of unshielded twist pair cables, fiber optic cables, or a combination thereof MCDN 100 may include digital subscribe line (DSL) compliant twisted pair connections between clients 120 and a node (not depicted) in access network 130 while fiber, cable or another broadband medium connects service provider resources to the node. In other embodiments, the broadband cable may extend all the way to clients 120.

As depicted in FIG. 1, switching network 140 provides connectivity for service provider 121, and may be housed in a central office or other facility of service provider 121. Switching network 140 may provide firewall and routing functions to demarcate access network 130 from the resources of service provider 121. In embodiments that employ DSL compliant connections, switching network 140 may include elements of a DSL Access Multiplexer (DSLAM) that multiplexes many subscriber DSLs to backbone network 170.

In FIG. 1, backbone network 170 represents a private network including, as an example, a fiber based network to accommodate high data transfer rates. Content acquisition resources 180 as depicted in FIG. 1 encompass the acquisition of various types of content including broadcast content, other “live” content including national content feeds, and VOD content.

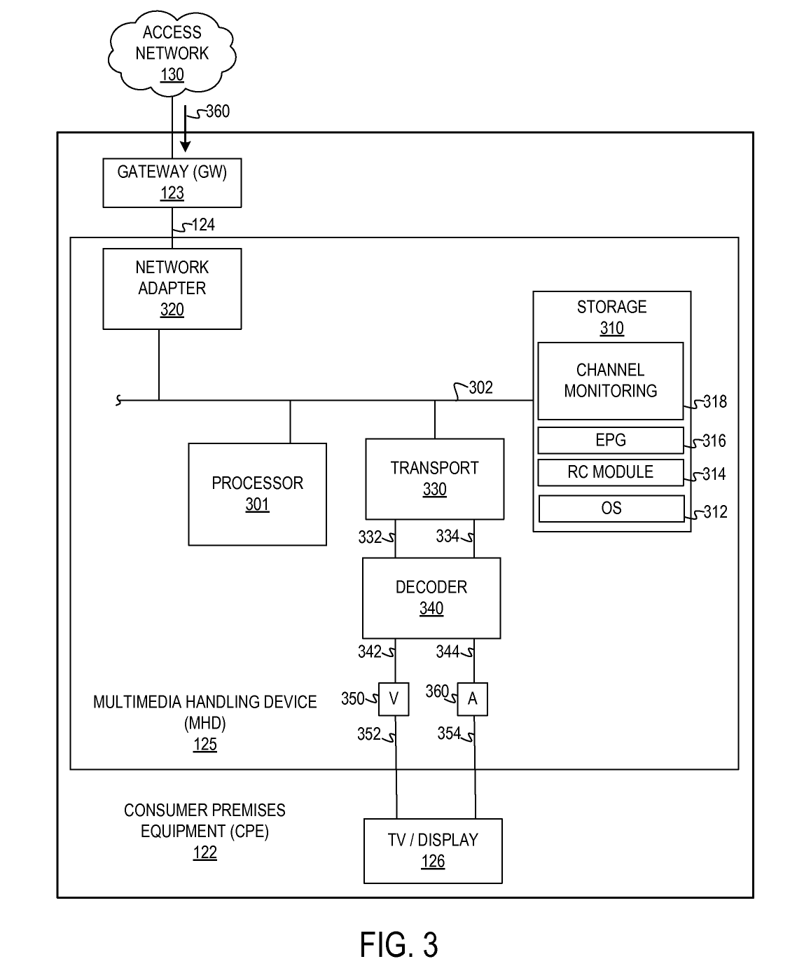

Thus, the content provided by service provider 121 encompasses multimedia content that is scheduled in advance for viewing by clients 120 via access network 130. Such multimedia content, also referred to herein as “scheduled programming,” may be selected using an electronic programming guide (EPG), such as EPG 316 described below with respect to FIG. 3. Accordingly, a user of MCDN 100 may be able to browse scheduled programming well in advance of the broadcast date and time. Some scheduled programs may be “regularly” scheduled programs, which recur at regular intervals or at the same periodic date and time (i.e., daily, weekly, monthly, etc.). Programs which are broadcast at short notice or interrupt scheduled programs are referred to herein as “unscheduled programming.”

Acquired content is provided to content delivery server 160 via backbone network 170 and switching network 140. Content may be delivered from content delivery server 160 to clients 120 via switching network 140 and access network 130. Content may be compressed, encrypted, modulated, demodulated, and otherwise encoded or processed at content acquisition resources 180, content delivery server 160, or both. Although FIG. 1 depicts a single element encompassing acquisition of all content, different types of content may be acquired via different types of acquisition resources. Similarly, although FIG. 1 depicts a single content delivery server 160, different types of content may be delivered by different servers. Moreover, embodiments of multimedia content delivery network 100 may include content acquisition resources in regional offices that are connected to switching network 140.

Although service provider 121 is depicted in FIG. 1 as having switching network 140 to which content acquisition resources 180, content delivery server 160, and application server 150 are connected, other embodiments may employ different switching networks for each of these functional components and may include additional functional components (not depicted in FIG. 1) including, for example, operational subsystem support (OSS) resources.

FIG. 1 also illustrates application server 150 connected to switching network 140. As suggested by its name, application server 150 may host or otherwise implement one or more applications for multimedia content delivery network 100. Application server 150 may be any data processing system with associated software that provides applications for clients or users. Application server 150 may provide services including multimedia content services, e.g., EPG, digital video recording (DVR), VOD, or PPV programs, IPTV portal, digital rights management (DRM) servers, navigation/middleware servers, conditional access systems (CAS), and remote diagnostics, as examples.

Applications provided by application server 150 may be downloaded and hosted on other network resources including, for example, content delivery server 160, switching network 140, and/or on clients 120. Application server 150 is configured with a processor and storage media (not shown in FIG. 1) and is enabled to execute processor instructions, such as those included within a software application. As depicted in FIG. 1, application server 150 may be configured to include program interruption application 152, which, as will be described in detail below, is configured to respond to interruptions of desired programs included in the multimedia content provided to client 120 of MCDN 100.

Further depicted in FIG. 1 is database server 190, which provides hardware and software resources for data warehousing. Database server 190 may communicate with other elements of the resources of service provider 121, such as application server 150 or content delivery server 160, in order to store and provide access to large volumes of data, information, or multimedia content. In some embodiments, database server 190 includes a data warehousing application, accessible via switching network 140, that can be used to record and access structured data, such as program or channel metadata used to identify the beginning and the end of program interruptions for clients 120, as will be discussed in detail below.

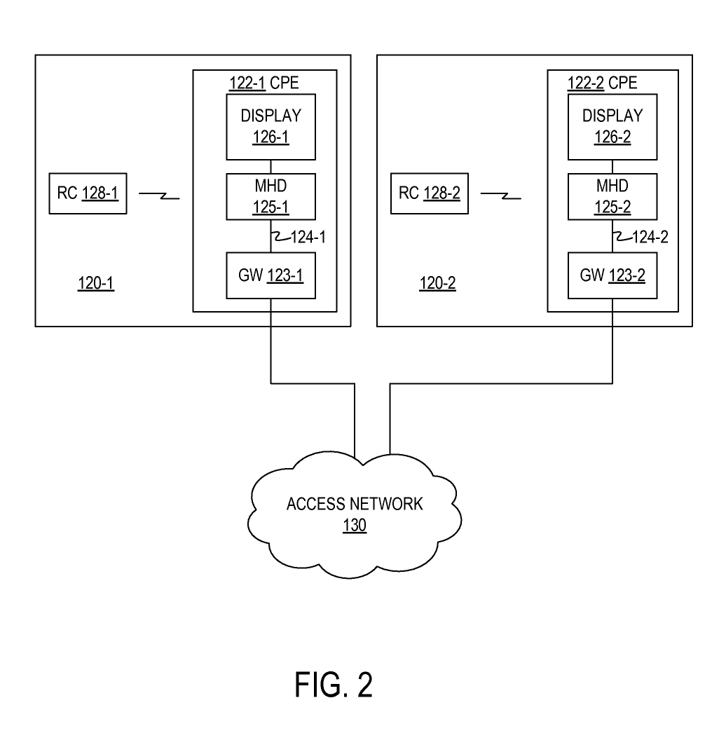

Turning now to FIG. 2, clients 120 are shown in additional detail with respect to access network 130. Clients 120 may include customer premises equipment collectively referred to herein as CPE 122. In the depicted embodiment, CPE 122 includes the following devices: gateway (GW) 123, multimedia handling device (MHD) 125, and display device 126. Any combination of GW 123, MHD 125, and display device 126 may be integrated into a single physical device. Thus, for example, CPE 122 might include a single physical device that integrates GW 123, MHD 125, and display device 126. As another example, MHD 125 may be integrated into display device 126, while GW 123 is housed within a physically separate device.

In FIG. 2, GW 123 provides connectivity for client 120 to access network 130. GW 123 provides an interface and conversion function between access network 130 and client-side local area network (LAN) 124. GW 123 may include elements of a conventional DSL or cable modem. GW 123, in some embodiments, may further include routing functionality for routing multimedia content, conventional data content, or a combination of both in compliance with IP or another network layer protocol. In some embodiments, LAN 124 may encompass or represent an IEEE 802.3 (Ethernet) LAN, an IEEE 802.11-type (WiFi) LAN, or a combination thereof. GW 123 may still further include WiFi or another type of wireless access point to extend LAN 124 to wireless-capable devices in proximity to GW 123. GW 123 may also provide a firewall (not depicted) between clients 120 and access network 130.

Clients 120 as depicted in FIG. 2 further include a display device or, more simply, a display 126. Display 126 may be implemented as a TV, a liquid crystal display screen, a computer monitor, or the like. Display 126 may comply with a display standard such as National Television System Committee (NTSC), Phase Alternating Line (PAL), or another suitable standard. Display 126 may include one or more integrated speakers to play audio content.

Clients 120 are further shown with their respective remote control 128, which is configured to control the operation of MHD 125 by means of a user interface (not shown in FIG. 2) displayed on display 126. Remote control 128 of client 120 is operable to communicate requests or commands wirelessly to MHD 125 using infrared (IR) or radio frequency (RF) signals. MHDs 125 may also receive requests or commands via buttons (not depicted) located on side panels of MHDs 125.

MHD 125 is enabled and configured to process incoming multimedia signals to produce audio and visual signals suitable for delivery to display 126 and any optional external speakers (not depicted). Incoming multimedia signals received by MHD 125 may be compressed and/or encrypted, digital or analog, packetized for delivery over packet switched embodiments of access network 130 or modulated for delivery over cable-based access networks. In some embodiments, MHD 125 may be implemented as a stand-alone set top box suitable for use in a co-axial or IP-based multimedia content delivery network.

Referring now to FIG. 3, a block diagram illustrating selected elements of an embodiment of MHD 125 is presented. In FIG. 3, MHD 125 is shown as a functional component of CPE 122 along with GW 123 and display 126, independent of any physical implementation, as discussed above with respect to FIG. 2. In particular, it is noted that CPE 122 may be any combination of GW 123, MHD 125 and display 126.

In the embodiment depicted in FIG. 3, MHD 125 includes processor 301 coupled via shared bus 302 to storage media collectively identified as storage 310. MHD 125, as depicted in FIG. 3, further includes network adapter 320 that interfaces MHD 125 to LAN 124 and through which MHD 125 receives multimedia content 360. GW 123 is shown providing a bridge between access network 130 and LAN 124, and receiving multimedia content 360 from access network 130.

In embodiments suitable for use in IP based content delivery networks, MHD 125, as depicted in FIG. 3, may include transport unit 330 that assembles the payloads from a sequence or set of network packets into a stream of multimedia content. In coaxial based access networks, content may be delivered as a stream that is not packet based and it may not be necessary in these embodiments to include transport unit 330. In a co-axial implementation, however, clients 120 may require tuning resources (not explicitly depicted in FIG. 3) to “filter” desired content from other content that is delivered over the coaxial medium simultaneously and these tuners may be provided in MHDs 125. The stream of multimedia content received by transport unit 330 may include audio information and video information and transport unit 330 may parse or segregate the two to generate video stream 332 and audio stream 334 as shown.

Video and audio streams 332 and 334, as output from transport unit 330, may include audio or video information that is compressed, encrypted, or both. A decoder unit 340 is shown as receiving video and audio streams 332 and 334 and generating native format video and audio streams 342 and 344. Decoder 340 may employ any of various widely distributed video decoding algorithms including any of the Motion Pictures Expert Group (MPEG) standards, and Windows Media Video (WMV) standards including WMV 9, which has been standardized as Video Codec-1 (VC-1) by the Society of Motion Picture and Television Engineers. Similarly decoder 340 may employ any of various audio decoding algorithms including Dolby® Digital, Digital Theatre System (DTS) Coherent Acoustics, and Windows Media Audio (WMA).

The native format video and audio streams 342 and 344 as shown in FIG. 3 may be processed by encoders/digital-to-analog converters (encoders/DACs) 350 and 360 respectively to produce analog video and audio signals 352 and 354 in a format compliant with display 126, which itself may not be a part of MHD 125. Display 126 may comply with NTSC, PAL or any other suitable television standard.

Storage 310 encompasses persistent and volatile media, fixed and removable media, and magnetic and semiconductor media. Storage 310 is operable to store instructions, data, or both. Storage 310 as shown includes sets or sequences of instructions, namely, an operating system 312, a remote control application program identified as remote control (RC) module 314, EPG 316, and channel monitoring 318. Operating system 312 may be a UNIX or UNIX-like operating system, a Windows® family operating system, or another suitable operating system. In some embodiments, storage 310 is configured to store and execute instructions provided as services to client 120 by application server 150, as mentioned previously.

EPG 316 represents a guide to the multimedia content provided to client 120 via MCDN 100, and may be shown to the user as an element of the user interface. The user interface may include a plurality of menu items arranged according to one or more menu layouts, which enable a user to operate MHD 125. The user may operate the user interface, including EPG 316, using remote control 128 (see FIG. 2) in conjunction with RC module 314. In some embodiments, program interruption application 152, in conjunction with EPG 316 and channel monitoring 318, provides functionality to resume a desired program after an interruption, as will now be described in further detail below.

A client of the MCDN may employ a decoding device to provide desired programming to a user. The user may select a primary viewing channel to receive and display a desired program. During an interruption of the desired program, the user may become distracted, or lose attention in the primary viewing channel. The distraction may be external, such as the user performing another activity unrelated to viewing the programming. The distraction may also be the result of user actions selecting one or more secondary viewing channels during the interruption.

In one embodiment, a beginning and an end of an interruption of a desired program may be detected. The interruption may be detected using channel metadata, which may represent tracking information for the programs being displayed on a given channel. Channel metadata may enable tracking a program using certain values, such as elapsed or remaining time, frame information, frame identifiers, counters, indices, or mathematical combinations thereof. In one embodiment, a counter counts individual frames of the desired program. Accordingly, the channel metadata may be used to detect a beginning and an end of an interruption of a program on a viewing channel.

The interruption may be at least one of a commercial, an advertising program, a public-service announcement, an emergency announcement, unscheduled programming, and a combination thereof. An interruption alert may be generated at the beginning of the interruption, and a resume alert may be generated at the end of the interruption. The interruption alert and the resume alert may be output to the user in audio, visual, haptic, or other forms, or combinations thereof. The interruption alert and the resume alert may be output to a remote control device for selecting channel, or to a wireless telephony device.

The resume alert may indicate to the user that the desired program is about to resume, or has resumed. In some embodiments, the desired program may be automatically resumed when the resume alert is issued. In certain cases, the user may be given an option to resume the desired program, or to continue with the currently selected channel, which may be different from the primary viewing channel.

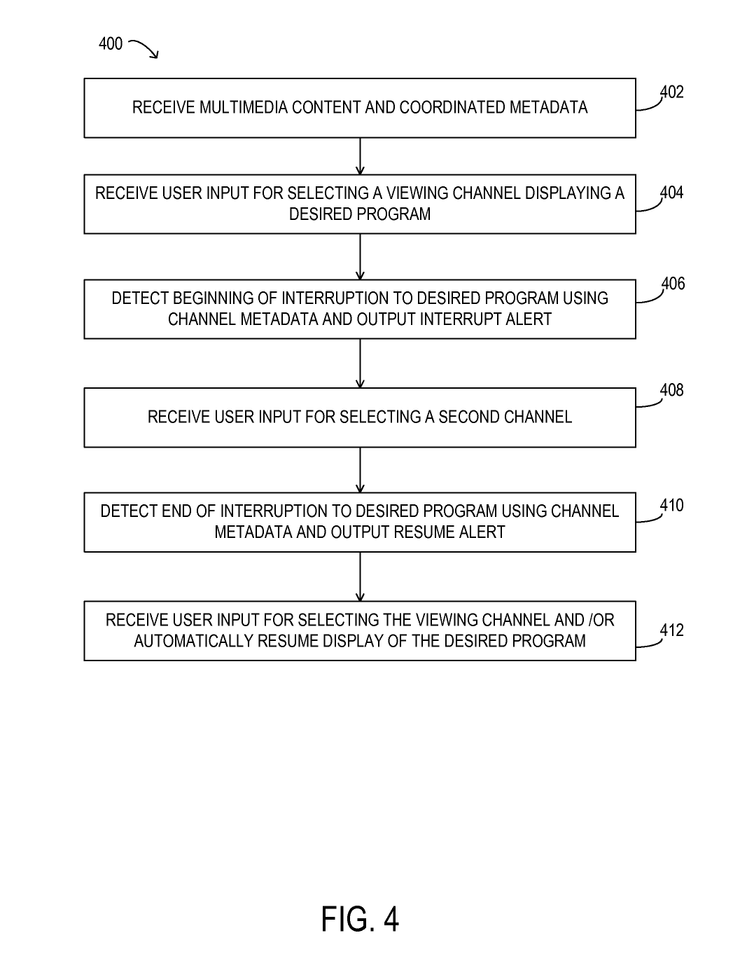

Turning now to FIG. 4, an embodiment of method 400 for resuming a selected viewing channel is illustrated. In one embodiment, method 400 is performed by a client device on the MCDN, such as MHD 125. Method 400 may also be performed in conjunction with program interruption application 152. It is noted that certain operations described in method 400 may be optional or may be rearranged in different embodiments.

Multimedia content may be received along with coordinated metadata (operation 402). In one embodiment, IPTV channels are received along with channel metadata. User input for selecting a viewing channel displaying a desired program may be received (operation 404). The user input may be received from a remote control device for selecting channels. The remote control device may be configured to operate an EPG for displaying and selecting channels. The viewing channel may begin to display the desired program, and the user may designate the viewing channel as the primary viewing channel in operation 404.

The beginning of an interruption to the desired program using channel metadata may be detected and an interrupt alert may be output (operation 406). The interrupt alert may be an audio, visual, or haptic alert, or a combination thereof. In some embodiments, the interrupt alert is generated or confirmed on the remote control device, or on a wireless telephony device. The user may be given the option to forward the interrupt alert to another device or another user using the MCDN.

User input for selecting a second channel may then be received (operation 408). In some embodiments, the second channel is selected after the interruption has begun. The user may select a number of different channels, or the EPG, as the second channel. In some embodiments, the user may browse several channels and before becoming distracted by a particular second channel. The end of the interruption to the desired program may be detected using channel metadata and a resume alert may be output (operation 410). The resume alert may be an audio, visual, or haptic alert, or a combination thereof. In some embodiments, the resume alert is generated or confirmed on the remote control device or on a wireless telephony device. The user may be given the option to forward the resume alert to another device or another user using the MCDN. In some embodiments, the resume alert includes a response option for resuming the viewing channel, for remaining at the second channel, or another action. The response option may be in the form of menu items on a display. User input is received for selecting the viewing channel and/or automatically resuming display of the desired program (operation 412). In some embodiments, the desired program is automatically resumed after a certain time if no further user input is received—that is, the lack of a response to the resume alert may be interpreted as user input for resuming the display of the desired program.

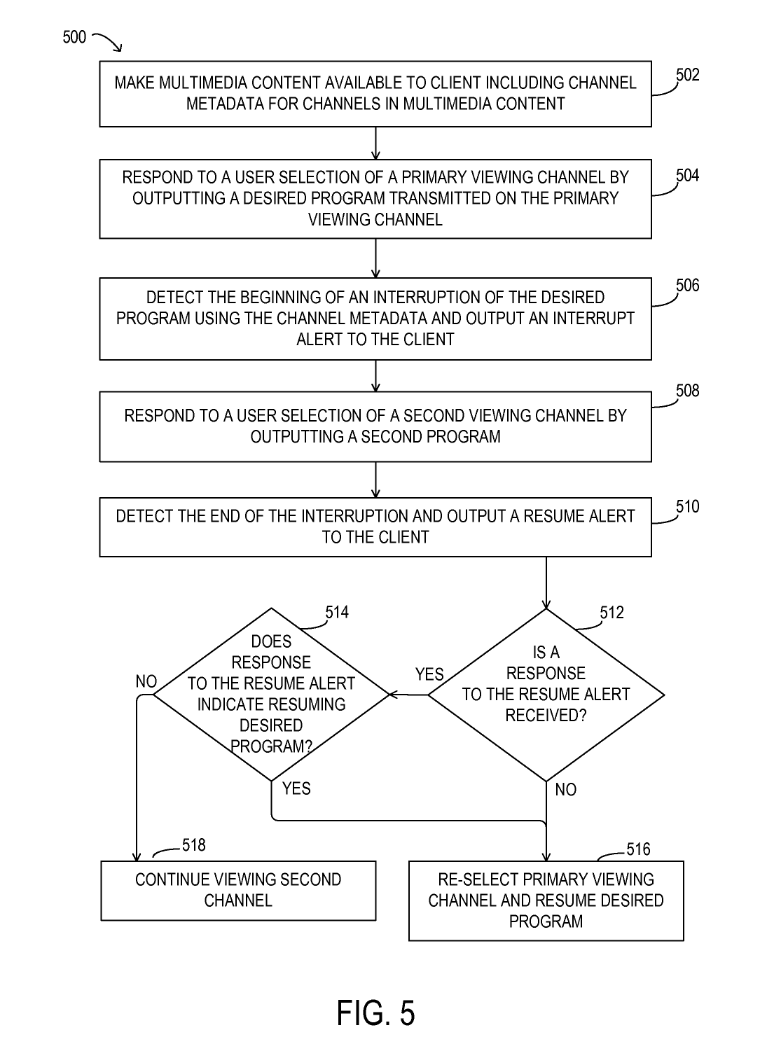

Turning now to FIG. 5, an embodiment of method 500 for resuming a selected viewing channel is illustrated. In one embodiment, method 500 is performed by program interruption application 152 on application server 150. Method 500 may also be performed in conjunction with a client device on the MCDN, such as MHD 125. It is noted that certain operations described in method 500 may be optional or may be rearranged in different embodiments.

Multimedia content including channel metadata for channels in the multimedia content is made available to a client (operation 502). Method 500 may then respond to a user selection of a primary viewing channel by outputting a desired program transmitted on the primary viewing channel (operation 504). The beginning of an interruption of the desired program may be detected using the channel metadata, and an interrupt alert may be output to the client (operation 506). In some embodiments, the interrupt alert is output to a user of the client in operation 506. Method 500 may then respond to a user selection of a second viewing channel by outputting a second program (operation 508). The second program may thus be displayed to the user during at least a portion of the interruption. The end of the interruption may then be detected and a resume alert output to the client (operation 510). In some embodiments, the resume alert is output to a user of the client in operation 510. The resume alert may include a means for the user to respond, such as a menu item or a prompt or another type of control option.

A decision is then made if a response to the resume alert is received (operation 512). If the result of operation 512 is YES, then a further decision is made if the response to the resume alert indicates resuming the desired programming (operation 514). If the result of operation 514 is NO, then method 500 continues by viewing the second channel (operation 518). If the result of operation 512 is NO or the result of operation 514 is YES, then the primary viewing channel is re-selected and the desired program is resumed (operation 516).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for accessing multimedia content over a multimedia content distribution network (MCDN), comprising:
receiving multimedia content from the MCDN, including receiving metadata coordinated in time with the multimedia content;
responsive to user input, selecting a primary viewing channel from a plurality of viewing channels available with the multimedia content, wherein said selecting indicates a desired program transmitted on the primary viewing channel; and
when an interruption of the desired program has ceased, outputting an alert indicating that the desired program has resumed transmission, wherein the metadata are used to identify the interruption.

2. The method of claim 1, wherein the plurality of viewing channels represent television channels.

3. The method of claim 2, wherein the television channels are provided by the MCDN as Internet-protocol television.

4. The method of claim 1, wherein the interruption of the desired program is a commercial interruption.

5. The method of claim 4, wherein the commercial interruption includes at least one advertising program.

6. The method of claim 1, wherein the alert is an audio alert.

7. The method of claim 1, wherein the alert is a haptic alert on a remote control device configured to control channel selection.

8. The method of claim 1, wherein a secondary viewing channel is selected after the interruption of the desired program begins, and wherein the alert is a visual alert with a control option to return to the primary viewing channel.

9. A system for accessing multimedia content over a multimedia content distribution network (MCDN), comprising:
a processor; and
memory media accessible to the processor, including processor executable instructions to:
decode multimedia content received from the MCDN, including receiving channel metadata coordinated in time for a plurality of viewing channels of the multimedia content;
respond to a user selection of a viewing channel from the plurality of viewing channels by outputting a desired program transmitted on the viewing channel; and
after an interruption of the desired program has ended, output an alert indicating that the desired program has resumed transmission, wherein the channel metadata are used to identify a beginning and an end of the interruption.

10. The system of claim 9, wherein the channel metadata include at least one counter value for tracking the duration that the desired program is transmitted.

11. The system of claim 10, wherein the counter value counts individual frames of the desired program.

12. The system of claim 9, wherein the channel metadata include at least one frame identifier used for identifying the desired program.

13. The system of claim 9, wherein the interruption is a commercial program.

14. The system of claim 9, wherein the alert is an audible alert.

15. The system of claim 9, wherein the alert is a haptic alert on a remote control device configured to control channel selection.

16. The system of claim 9, further comprising program instructions executable to:
after the interruption of the desired program begins, output a message indicating that the interruption has been detected.

17. The system of claim 9, further comprising program instructions executable to:
respond to a user selection of a second channel from the plurality of viewing channels by outputting a second program transmitted on the second channel.

18. The system of claim 17, wherein the alert is a visual alert with a response option to return to the viewing channel.

19. Computer-readable memory media, including instructions for processing multimedia content delivered over a multimedia content distribution network (MCDN), said instructions executable to:
make a plurality of viewing channels available to a client of the MCDN;
respond to a user selection of a viewing channel from the plurality of viewing channels by outputting a desired program transmitted on the viewing channel;
detect, from metadata included with the viewing channel, a beginning and an end of an interruption of the desired program; and
after detecting the end of the interruption of the desired program, output a resume alert to the client indicating that the desired program has resumed.

20. The memory medium of claim 19, further comprising program instructions executable to:
after the interruption has begun, output an interrupt alert to the client indicating that the desired program has been interrupted.

21. The memory medium of claim 19, wherein the interruption is an advertisement.

22. The memory medium of claim 19, wherein the interruption is unscheduled programming.

23. The memory medium of claim 19, further comprising program instructions executable to:
during the interruption, respond to a user selection of a second channel by outputting a second program transmitted on the second channel, wherein the resume alert is a visual alert.

24. The memory medium of claim 23, wherein the visual alert is a menu prompt including an option to cancel the resume alert and continue viewing the second channel.

25. The memory medium of claim 23, wherein the visual alert is a display element on a wireless remote control device for selecting viewing channels.

26. The memory medium of claim 19, wherein the resume alert includes a response option to return to the viewing channel.

27. The memory medium of claim 19, wherein the resume alert is an audible alert.

28. The memory medium of claim 27, wherein the audible alert is a voice alert.

29. The memory medium of claim 19, wherein the resume alert is a haptic alert.

30. The memory medium of claim 29, wherein the haptic alert is implemented on a wireless telephony device.
